(19) United States
(12) Patent Application Publication
(10) Pub. No.: US 2018/0224027 A1
(43) Pub. Date: Aug. 9, 2018

(54) FLEXIBLE PIPE CONNECTOR AND METHOD OF USING THE SAME

(71) Applicant: RADIUS SYSTEMS LIMITED, Alfreton Derbyshire (GB)

(72) Inventor: Derek MUCKLE, Long Whatton Leicestershire (GB)

(21) Appl. No.: 15/747,946

(22) PCT Filed: Jun. 23, 2016
(86) PCT No.: PCT/GB2016/051878

§ 371 Date: Jan. 26, 2018

(30) Foreign Application Priority Data
Jul. 27, 2015 (GB) 1513207.9

(51) Int. Cl. F16L 11/15; F16L 27/11; F16L 25/00; F16L 11/11

(52) U.S. Cl. CPC F16L 11/15; F16L 11/11; F16L 25/0036; F16L 27/11

(57) ABSTRACT

A flexible pipe connector (200) for joining a pressurised mains pipe to a service pipe, the connector comprising: • a corrugated longitudinal body portion (202) having a first end (208), a second end (210) and an internal bore therebetween, said longitudinal body portion further comprising a plurality of corrugations spaced along the length thereof, the corrugations defining a maximum internal diameter of the bore at a peak 204 of a corrugation and a minimum internal diameter of the bore at a trough (206) of a corrugation; • a first spigot socket (212) at said first end of the longitudinal body portion; and • a second spigot socket (214) at said second end of the longitudinal body portion; • wherein for a defined volumetric flow rate, the head loss of a fluid flowing through said body portion is no greater than if the fluid were flowing in a smooth bored pipe of the same length and having the same internal diameter as the first and second spigot sockets; and • wherein the minimum internal diameter of said corrugated internal bore is greater than the maximum internal diameter of said first and second spigots.

This invention relates to a flexible pipe connector and method using the same. In particular, but not exclusively, the invention relates to a flexible pipe connector and method for joining a pressurised mains pipe (such as that used for the supply of combustible gases or water) to an individual service pipe (such as that carrying the supply to an individual domestic property). Specifically, the invention seeks to mitigate existing problems associated with renovating old pipe infrastructures.

### Background

Following its initial introduction, many utility companies in Western Europe chose to specify synthetic polyolefin, such as polyethylene, for small diameter service pipes that connect the main utility distribution pipe (or ‘main’) to a consumer's dwelling house. The distribution pipe continued for some time to be laid in ductile iron for example, thus a hybrid metal and plastic pipe system was installed.

Ductile iron laid in the mid 1900s is known to have a shorter asset lifetime than synthetic polyolefin pipes and, in many developed countries, is subject of large scale replacement programmes. The United Kingdom is one such example whereby grey cast iron and ductile iron pipes used for the supply of methane gas are subject of a national replacement programme to avoid unplanned failures as iron pipes wear out. This replacement is part of a long term programme to remove risk from the UK's national gas distribution asset base and requires the replacement of all old iron and steel gas distribution and service pipes within 30 metres of a habitable dwelling house within 30 years (known as the 30:30 programme).

One method, known in the art, of replacing an iron pipe is to use the iron pipe as a conduit in the ground, inserting a synthetic polyolefin pipe of smaller diameter inside the original iron pipe. In the United Kingdom, iron pipes were originally constructed for ‘town’ gas made from coke. Following conversion of the UK gas supply to natural gas, having a higher calorific value, the volume of gas required to be supplied has reduced. As such, replacing old iron piping using this method is possible in more than 80% of all cases in the UK.

When a pipe of a smaller diameter is inserted in this way, the original service pipe connection to the iron main needs to be transferred to the inserted pipe. Generally, this is done by first disconnecting the service pipe by cutting the pipe close to a connection on the metallic pipe and subsequently cutting out a section of the iron pipe in the ground where the connection exists. This stage of disconnecting the service pipe is undertaken prior to the insertion of the replacement polyolefin pipe.

Following insertion of the replacement polyolefin pipe main, the small diameter polyolefin service pipe must be reconnected from the consumer's dwelling house to the newly inserted pipe main. It is conventional practice to ensure that reconnection can be achieved using a range of standard components designed specifically for pressure pipe applications. Typical practice is described below, with reference to the well-known technology of electrofusion, though the same solution is also achievable using mechanical fittings technology.

A tapping tee, examples of which can be found in EP2215394 B1 and GB2451080 B, is first welded to a visible portion, known in the art as a crown, of the inserted polyolefin pipe, the crown being visible due to a section of the original iron pipe having first been removed. This provides a connection to the new polyolefin pipe main and can be drilled to form a fluid connection channel by the use of an integral cutter system. A tapping tee is provided with an outlet of a fixed height above the crown of the polyolefin pipe, and is oriented in the direction of the consumer's dwelling house. The tapping tee is rotationally fixed with respect to the main and the outlet therefore projects substantially perpendicular to the supply main. The outlet is normally a reduced diameter, the same, or close to, the diameter of the service pipe to which it will be connected. As the service pipe has been cut previously, there exists a linear gap between the end of the service pipe and the outlet of the tapping tee to which it will be connected. It is normal practice in such situations to first use a coupler or reducer fitting to make a connection to this pipe and fit an extension piece to close the linear gap.

Another known method of closing the linear gap is to use the flexibility of the synthetic polyolefin pipe to bend the service pipe by hand sufficient that the end of the tapping tee and the extended pipe can be brought into alignment and thus joined using a coupler or reducer socketed fitting. This however is not usually the norm and often requires large excavations in order that the service pipe can be bent with a reasonable bend radius.

Two significant problems are associated with the current state of the art. Firstly, the centreline heights of the tapping tee and of the service pipe are not usually aligned due to a height difference. This is due, in part, to the use of a smaller diameter pipe that is constrained inside the original iron pipe and standard tapping tee components that do not match the geometry of the original iron pipe construction. At present, there is not a ‘standard’ for construction due to a range of different manufacturers products being specified over many years, resulting in a range of inserted pipe diameters being used for a given iron pipe size. It is not practical to make a tapping saddle, such as that disclosed in EP2215394 B1, of a custom geometry to remedy this situation. Secondly, identifying the desired location of a plastic service pipe connection to an iron main is not an exact science. There is no standardized means of surveying a location; the skilled persons generally rely on estimation. Therefore when an excavation is first made, it may not be centred over the location of the service pipe connection. As the excavation is often the most costly element of construction, increasing the size of a hole dug once the connection has been revealed, is undesirable. Connections may thereby be biased significantly to one side or face of the excavation. The above gives rise to the problem of making a connection to a service pipe that is spatially separated from the tapping tee both in terms of height difference and lateral offset.

FIG. 1A shows an excavation site 100 that is typical during the joining of an individual service pipe 102 to a pressurised mains supply pipe 104. Conventionally, a tapping tee assembly 106 having an outlet 108 is affixed by a saddle 109 to a plastics pressurised pipe 104. In the instance wherein an iron pipe has been relined with a plastics liner, as described above, the tapping tee assembly 106 may be affixed by its saddle 109 to a crown portion of the plastics liner, as described above. For clarity purposes, this example is not illustrated. Individual service pipe 102 has an opening 103 which needs to be joined to the outlet 108 of the tapping tee assembly 106. In the example illustrated in FIG. 1A, the outlet 108 of the tapping tee assembly 106 extends substantially parallel to the Z axis 114 and perpendicularly to the X 110 and Y 112 axes. In contrast, the opening 103 of the service pipe 102 extends substantially parallel to the X axis 110 and perpendicularly to the Y 112 and Z 114 axes.

In the pressure pipe market, one solution conventionally used to make a connection between the outlet 108 of the tapping tee 106 and the opening 103 of the individual service pipe 102 is to arrange together a plurality of elbow fittings and short pipe stubs, as illustrated in FIG. 1B. It will be appreciated that using this method requires a minimum of three fittings to connect the tapping tee to the service pipe in the illustrated example. In the example shown in FIG. 1B, a first elbow 116, used to turn the outlet 108 through 90 degrees in a direction parallel to the Y axis 112. A first pipe stub 118 extends an opening of the first elbow 116 to a location on the Y axis 112 which is in line with the opening 103 of the individual service pipe 102. However, as can be seen in FIG. 1B, this point, whilst aligned with the opening 103 in the Y axis 112, is still offset from the opening 103 on both the X 110 and Z 114 axes. A second elbow 120 turns the first pipe stub 118 through 90 degrees in a direction parallel to the Z axis 114, to which second pipe stub 122 is joined in order to approximate the linear offset between an opening of the second elbow 120 and the opening 103 in the Z axis 114. Finally, a third elbow 124 turns the second pipe stub 122 through 90 degrees in a direction parallel to the Y axis 112. A third pipe stub (not illustrated) may be needed to connect to the opening 103 of the service pipe 102 or, as illustrated, the third elbow 124 may connect directly

Not only is this method inefficient, but the method also causes concerns amongst industry regulators. Within pipeline engineering in general it is perceived that joints that form a network are ultimately the least reliable element and likely to be a cause of either early life or late life wear out failures in the network. The more joints that are formed in a pipe construction, the higher the risk of wear out failure. For gas distribution engineers, the greatest perceived risk in the supply of combustible gases exists in close proximity to dwelling houses. A small leak even on a low pressure gas system, say, within 30 meters of a dwelling house, can give rise to a gas in house event, with significant likelihood of explosion occurring. Indeed in the UK this is a driver behind the gas distribution system mains replacement programme. As such, the use of multiple joints in a pipeline construction in such close proximity to a dwelling house is highly undesirable.

In other general conduit markets, such as non-pressure cable and telecom systems, corrugated pipe forms may be used in short lengths to form a connection between two connection points that are offset from one another. In pipeline engineering this is best known in the “soil and waste” sector, for house plumbing systems. In this example, a waste or drainage flow path, for example from a sink unit, is completed using a short length of single wall corrugated pipe form that is made using a spigot and socket jointing system. In such an example the corrugated form is made by an extrusion process and spigot ends are formed onto the pipe using an overmoulding process. The spigots are then sized and shaped to give compatibility to standard socket fittings used in this type of application. In use, the corrugated pipe is manually bent to shape and the spigots inserted to sockets to complete an offset construction.

In the field of pressure pipes however, corrugated pipes constructed from synthetic polyolefins are unknown, particularly for the use of pressurized gas distribution, where the gold standard is typically to use solid wall single or multilayer extruded pipe forms. Every peak in diameter on a corrugated conduit results in an expansion and immediately thereafter a contraction in the flow channel. This expansion and contraction causes a velocity head loss that dissipates the pressure head available to drive a gas along the pipe. This presents a safety risk, as a minimum delivery pressure is required at a consumer's dwelling house in order that appliances will operate at the correct stoichiometric ratio for safe combustion.

The closest known variation of corrugated pipes in the pressurised pipe sector is a specialist pipe renovation system known by the trademark “ServiFlex®”. FIG. 10 illustrates ServiFlex® pipe 130 http://www.radius-systems.com/products/gas-systems/service-pipe-relining/serviflex/, a corrugated pipe for relining 1 inch steel gas service pipes. ServiFlex® pipe 130 has been accepted in the gas distribution sector only as a renovation product, forming part of a composite pipe structure. ServiFlex® pipe 130 is inserted inside a metal conduit and a sealant is used to fill the annulus formed therebetween. ServiFlex® pipe has a twin wall structure, with a corrugated exterior wall 132 and a smooth interior lining layer 134, which lines a bore 216. The corrugated external form comprises peaks 138 and troughs 140 and enables appropriate shaping to provide flexibility in bending, whilst maintaining a hoop strength sufficient to contain gas pressure exerted on the pipe wall. Without the smooth internal lining layer 134, issues relating to flow characteristics of gas throughout the bore 216 would arise as a result of the corrugated peaks 138. The additional smooth internal lining layer 134 of ServiFlex® pipe 130 solves the problem described above of velocity head loss caused by expansion and contraction by minimizing any significant pressure head loss whilst gas is flowing through the bore 216. In practice, this solution involves a complex production process and is not always economic or practical to consider.

The present invention seeks to mitigate the above described problems.

What is both needed in the art and provided by the present invention, is a fitting that is compatible with conventional pipe fittings, which has a pressure drop of no greater than the traditional smooth pipe it replaces and which is capable of containing pressure of a service fluid over the long term.

An aim of the present invention is to reduce the multiplicity of jointed connections between joined pressurised pipes and individual service pipes.

A further aim of the present invention is to reduce risk of gas leaks, particularly close to dwelling areas.

Further still, an aim of the present invention is to simplify repair installations, should a connection between a pressurised supply pipe and an individual service pipe become damaged.

### BRIEF SUMMARY OF THE DISCLOSURE

In accordance with a first aspect of the present invention there is provided a flexible pipe connector for joining a pressurised mains pipe to a service pipe, the connector comprising:

a corrugated longitudinal body portion having a first end, a second end and an internal bore therebetween, said longitudinal body portion further comprising a plurality of corrugations spaced along the length thereof, the corrugations defining a maximum internal diameter of the bore at a peak of a corrugation and a minimum internal diameter of the bore at a trough of a corrugation;

a first spigot socket at said first end of the longitudinal body portion; and

a second spigot socket at said second end of the longitudinal body portion;

wherein for a defined volumetric flow rate, the head loss of a fluid flowing through said body portion is no greater than if the fluid were flowing in a smooth bored pipe of the same length and having the same internal diameter as the first and second spigot sockets,

wherein the minimum internal diameter of said corrugated internal bore is greater than the maximum internal diameter of said first and second spigots.

In an embodiment of the present invention, said first and/or second spigot sockets have an outside diameter of 25 mm.

In an embodiment of the present invention, said first and/or second spigot sockets have a wall thickness of 2.3 mm.

Preferably said first and/or second spigot sockets have dimensions determined by international, national and/or regional standards for polyethylene pressure pipe systems.

In an embodiment, the minimum internal diameter of said corrugated internal bore is greater than the maximum internal diameter of said first and second spigots.

Preferably said corrugations are equally spaced along the length of the corrugated body portion.

In an embodiment, the minimum outside diameter of said corrugated body portion is 32 mm.

In an embodiment, the volumetric flow rate is up to 4 standard cubic metres per hour.

In an embodiment, the fluid flowing through the flexible pipe is natural gas.

At least one of said spigot sockets may be suitable for primary connection to a pressurised mains pipe, or tapping tee thereon.

At least one of said spigot sockets may be suitable for repair connection to a replacement corrugated body portion.

Preferably said spigot sockets are more than twice the length required for a normal connection and/or said spigot sockets are longer than a conventional pipe stub. . . .

In an embodiment the corrugated body portion has a bend radius of 1 D-1.5 D.

The flexible pipe connector may comprise synthetic polyolefin and/or may be a unitary integrally-formed component.

According to a second aspect of the invention there is provided a method for joining a pressurised mains pipe to an individual service pipe comprising the steps of:

disconnecting the pressurised mains pipe from service;

providing a flexible pipe connector as claimed in any of the preceding claims;

attaching said first spigot socket of the flexible pipe connector to the mains pipe;

bending said corrugated body portion of the flexible pipe connector such that said second spigot socket is aligned with an opening of the service pipe; and

attaching said second spigot of the flexible pipe connector to the service pipe.

In an embodiment, said first spigot socket is attached to the mains pipe via a tapping tee.

According to a third aspect of the invention there is provided a kit for connecting a pressurised mains pipe to an individual service pipe comprising a flexible pipe connector as described in any of the preceding paragraphs, the kit further comprising a tapping tee assembly. The kit may comprise a length of plastics pipe for lining the pressurised mains pipe. Said length of plastics pipe may be a polyolefin pipe. In an embodiment, the flexible pipe connector is supplied factory jointed to the tapping tee assembly.

Further features of the invention are defined in the appended claims.

Certain embodiments of the invention provide the advantage that the requirement multiplicity of jointed connections in the standard construction method outlined above is eliminated, thereby reducing risk associated with link between number of joints and chances of gas leak or gas in house situations, as well as reducing installation time and costs.

Certain embodiments of the invention provide the advantage that the flexible pipe connector can be bent into a tight bending radius.

Certain embodiments of the invention provide the advantage that the flexible pipe connector exhibits sufficient hoop strength to resist externally imposed ground loads and contain gas pressure exerted on the pipe wall.

### BRIEF DESCRIPTION OF THE DRAWINGS

Embodiments of the invention are described herein by way of example only, with reference to the accompanying drawings, in which:

FIG. 1A (PRIOR ART) is a cutaway view of an excavation site exposing a mains service pipe with a tapping tee welded thereon and a service pipe to be connected;

FIG. 1B (PRIOR ART) illustrates a known solution for joining the pressurised mains pipe to the service pipe of FIG. 1A;

FIG. 10 (PRIOR ART) illustrates a ServiFlex® pipe;

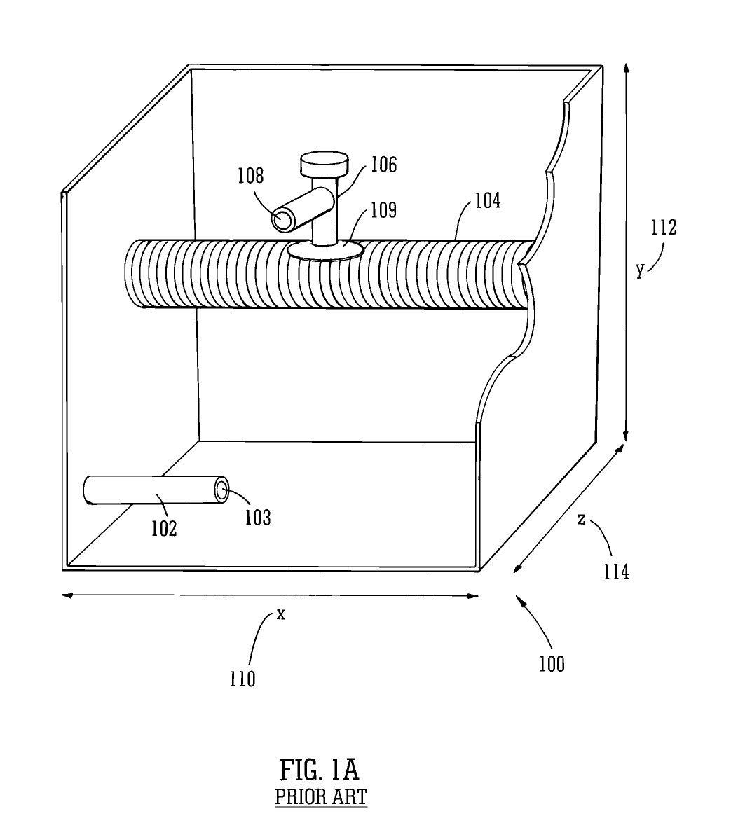

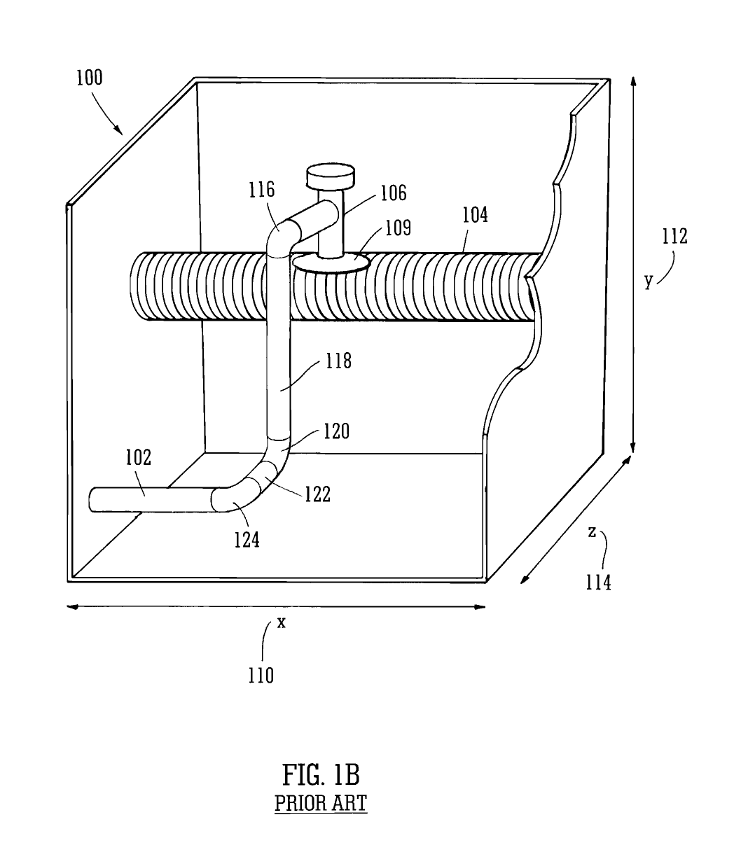

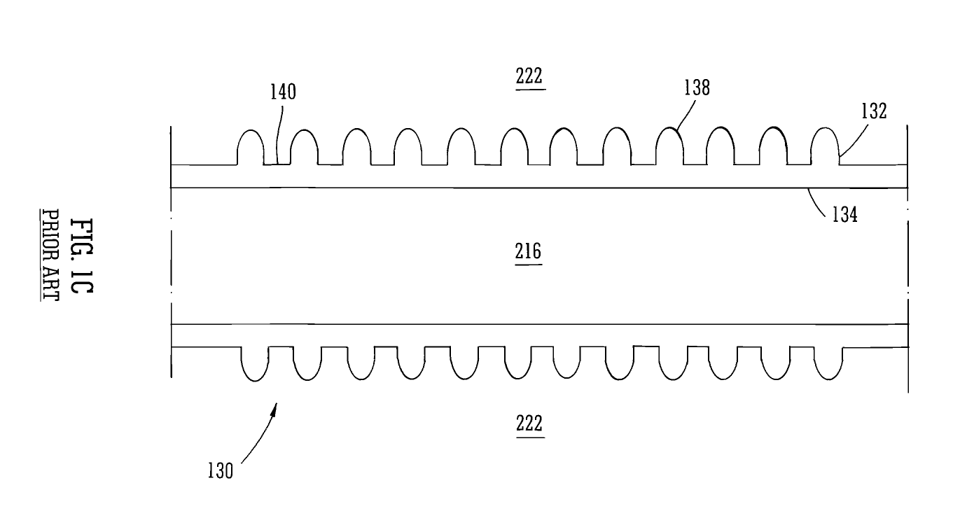

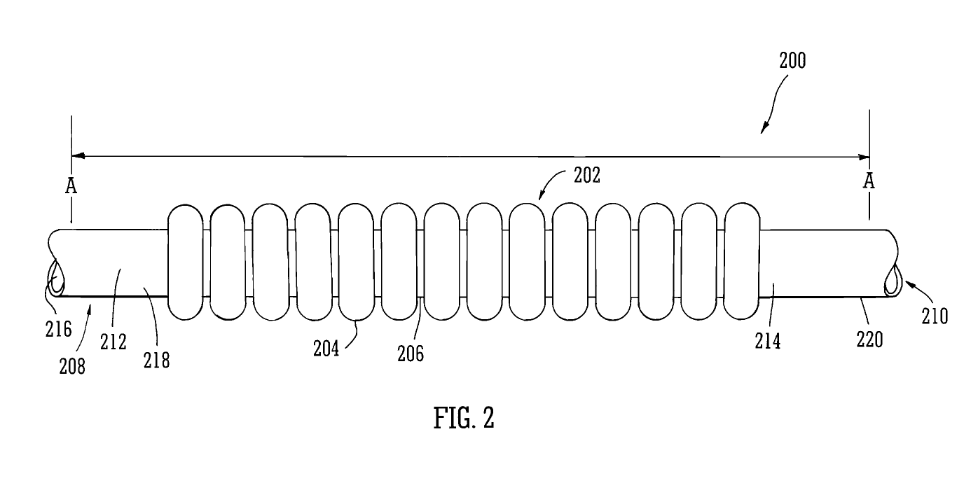

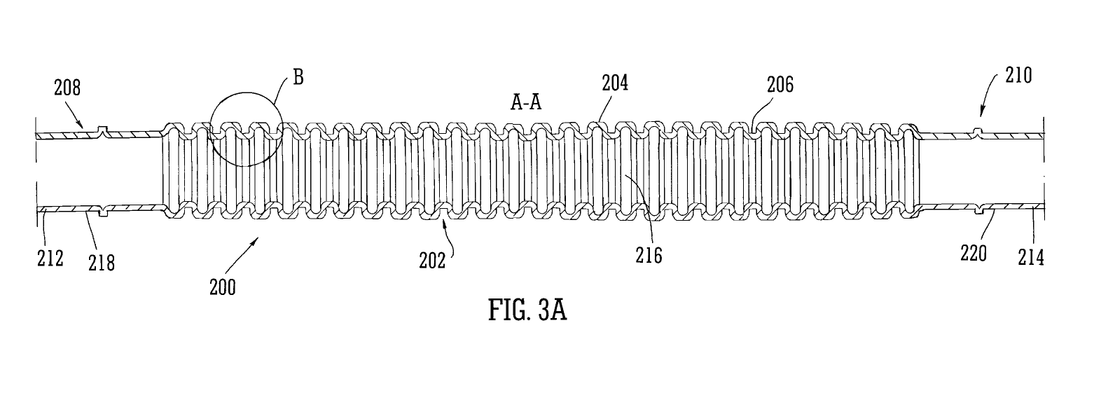

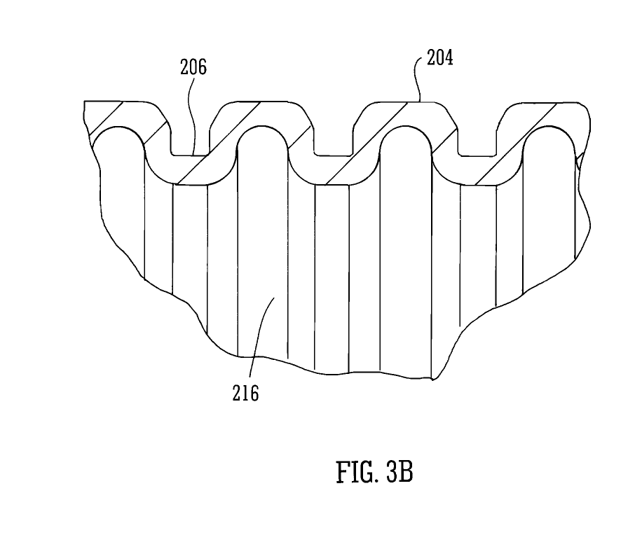

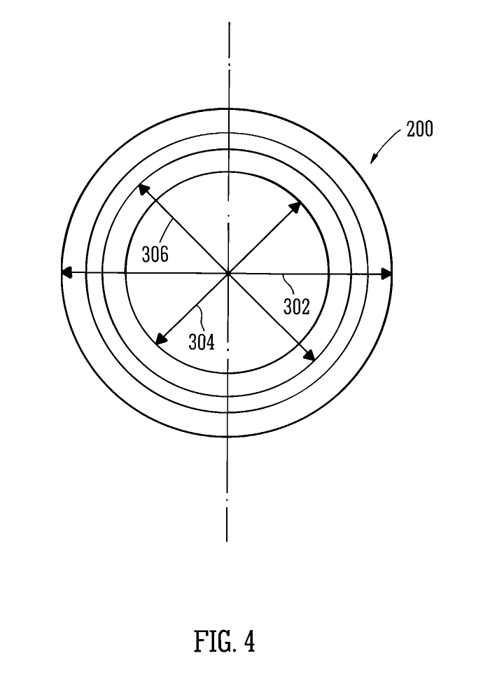

FIG. 2 is a flexible pipe connector in accordance with an embodiment of the invention;

FIG. 3A is a cross sectional view of the flexible pipe connector of FIG. 2, as viewed along the line A-A;

FIG. 3B is an enlarged view of section B of FIG. 3A; and

FIG. 4 is an end view of a flexible pipe connector in accordance with an embodiment of the invention.

### DETAILED DESCRIPTION

As shown in FIG. 2, a pipe connector 200 comprises a flexible length of pipe having at its first end 208 a first spigot socket 212 and at its opposing end 210 a second spigot socket 214. A corrugated longitudinal body portion 202 has equally spaced corrugations which define a maximum internal diameter of the body portion at the peaks 204 of the corrugations and a minimum internal diameter of the body portion at the troughs 206. The body portion 202 connects the two spigot sockets 212, 214, each spigot socket having a spigot tail 218, 220. A bore 216 extends throughout the length of the corrugated body portion from the first spigot socket 212 to the second spigot socket 214.

Referring to FIGS. 3A and 3B, the single wall body portion 202 has a profile geometry which is selected and sized such that despite the presence of the corrugations, the volumetric flow rate through the longitudinal body portion 202 is substantially equal to the volumetric flow rate through the spigot sockets 212, 214. In other words, the head loss through the longitudinal body portion 202 is approximately the same as would be expected if the corrugated longitudinal body portion were replaced by a non-corrugated or smooth bored pipe of the same length and an internal diameter determined by the desired volumetric flow rate.

This arrangement ensures a constant flow profile through both the internal bore of the longitudinal body portion and through the spigot sockets. In the illustrated example, the smooth spigot tails 218, 220 have a wall thickness of 2.3 mm and a total diameter inclusive of wall thickness of 25 mm. This is termed “25 SDR 11”, wherein SDR indicates ratio of diameter to wall thickness. The spigot tails 218, 220 conform to the size described but then smoothly transition into the corrugated longitudinal body portion 202 of the pipe 200. Each peak 204 has a larger diameter inclusive of wall thickness of 32 mm, with a wall thickness that is generally thinner than that of the spigot tails 218, 220, thereby creating a larger diameter in the bore 216 than at the spigot tails 218, 220 or troughs 206. The velocity of gas flowing through the corrugated portion is reduced in comparison to the 25 SDR 11 spigot ends, but a constant volume nevertheless continues to flow. As such, the velocity head loss associated with each expansion and contraction of the peaks 204 and troughs 206 along the connector is mitigated by the reduced velocity of the gas passing therethrough. Using this concept, it is possible to achieve comparable head loss through the corrugated longitudinal body portion as through a smooth bore pipe of dimensions equivalent to that of spigot tails 218, 220 for a desired volumetric flow range by making peaks 204 taller (i.e. of larger diameter) than the skilled person might otherwise expect.

The corrugated body portion can be formed to tight bends as small as 1 D to 1.5 D bend radius, whilst resisting external dynamic and static forces imposed by the surround ground structure together with the internal forces created as a result of internal fluid or gas pressure and thermal effects acting on the structure.

In an installation where gas flows from spigot 220 in a direction towards and through spigot 218, spigot 220 is designed to engage with an opening 108 of a tapping tee assembly 106. In this embodiment the spigot 218 will be joined using a coupler to the open end 103 of the existing plastic service pipe 102. The length of the spigots 218 and 220 so joined is nominally 40% of the total length of the smooth spigot and no more than 50% in any event.

Multiple joints within the structure may give rise to additional failure risk, thereby increasing the risk of gas leak and as such, the spigot tails 218, 220 in this example can be integrally formed with the corrugated body portion 202 as one unitary component. The spigot tails 218, 220 conform to standard dimensions set out in industry standards with regards to diameter, wall thickness, ovality and length. This provides the advantage that the flexible pipe connector 200 is compatible with other joining technologies available to the user.

In the event of damage occurring to the corrugated body portion 202 such as a puncture of the pipe, the pipe can be cut at the junction between the corrugated body portion 202 and the smooth spigot 220. This leaves behind a severed spigot 220 whose dimensions meet industry standards for a conventional pipe stub. A replacement pipe piece can be readily joined to restore the system. In the same way, damage to a downstream pipe section can be remedied by cutting spigot 218 mid length to leave a shortened spigot suitable for jointing replacement pipework. In this way it is possible to replace damaged pipework immediately in the vicinity of the unconventional corrugated body portion 202.

If the corrugated longitudinal body portion 202 itself becomes damaged, the end closest to the tee connection will likely be cut at the position where the last peak transitions to the smooth spigot. This would leave behind the full length of the spigot with 50% welded into the tee and 50% available as a standard pipe stub for a new piece of pipe to be welded to. The same applies at the downstream end where damage may occur in the section immediately next to the pipe connector 200 and in order to repair this, the 50% of the spigot that is welded may require cutting, in order to remove the damaged section, leaving a shortened spigot on the pipe connector 200 to which a new piece of pipe can be connected. The former repair situation is more likely in practice than the latter.

In another embodiment of the present invention, the flexible pipe connector 200 is supplied as part of a kit further comprising a tapping tee assembly 106. It is preferable that the tapping tee assembly is factory jointed to the tapping tee assembly under controlled conditions, in order to increase joint integrity from a factory assured source rather than a below ground construction environment. This limits onsite construction risks to a single connection wherein the flexible conduit is connected to the cut end of the service pipe, thereby improving system reliability.

It is desirable to provide a connector that is compatible with conventional pipe fittings, which has a head loss no greater than that of the traditional smooth bored pipe it replaces and which is capable of containing pressure of a service fluid over the long term. Generally, when a length of pipe between a supply main and a residential property must be replaced, a gas engineer first makes an assessment of the gas load in a residential property. By assessing the number of appliances in place, or estimating a reasonably expected number of appliances for the size of dwelling house, the gas engineer can determine what the peak load requirements might be for a given gas supply. In the example of the United Kingdom, the default flow rate from a supply main to a residential property could be, for example, 4 standard cubic metres per hour (SCMH) of natural gas. Having established the load at the property the engineer subsequently identifies the length of the connection required between the supply main and the position of a meter in the residential property. Finally, the available pressure in the supply main under conditions of peak network loading is established. In a low pressure network, this might typically be of the order of 25 to 30 millibar (gauge).

In order to select the correct size pipe for the installation, the gas engineer must deliver a minimum pressure head at the meter (typically 19 millibar gauge in the UK) under conditions of peak loading. Therefore taking the above example, at the flowrate of 4 SCMH, with the supply main at 25 millibar and the minimum delivery pressure of 19 millibar, the maximum pressure which may be lost across the length of the service pipe whilst still maintaining the minimum 19 millibar delivery pressure is 6 millibar.

In smooth bored pipes, the pressure drop (also referred to as head loss) across the length of the service pipe predominantly occurs as a result of frictional head loss, where the gas drags on the pipe surface. The worst case head loss occurs at maximum flowrate. Taking the above example of a 4 SCMH natural gas flow and the maximum allowable pressure drop of 6 millibar with a pipe length of say, for example, 20 metres, then:

Selecting a 20 SDR 9 pipe generates a head loss of 6.2 millibar

Selecting (conventionally, the next size up) a 25 SDR 11 pipe would generate a head loss of 1.7 millibar

Therefore a 25 SDR 11 pipe would be selected in this instance as being the smallest pipe dimension with a sufficiently low head loss, i.e. a head loss of less than the maximum allowable head loss.

### Head Loss

The example scenario above wherein a 25 SDR 11 smooth bored pipe has been selected in order to achieve a certain outcome for gas flowing in the pipe (i.e. a design flowrate and minimum pressure at point of delivery) can be considered in relation to the claimed invention. The claimed pipe connector does not have a smooth bored pipe as above, but instead comprises smooth bored spigot sockets 218, 220 and a corrugated body portion 202 in between. In contrast to smooth bored pipes, rather than simple friction, the head loss generated by gas flowing through the claimed pipe connector is attributable to three components:

frictional head loss particularly in the integral smooth pipe spigot sections 212, 218

velocity head loss at each cross sectional expansion (i.e. at each peak 204), and

velocity head loss at each cross sectional contraction (i.e. at each trough 206)
Head loss is typically expressed as a function of velocity squared:

$${h}_{x} = k . \frac{{u}^{2}}{2 g} \qquad Equation 1$$

Where:

hₓ=head loss

k=factor relevant to the parameter (e.g. velocity, friction)

u=velocity of the fluid flowing

g=gravitational constant
A ‘k’ factor may be derived by formulae or empirical means. For example, a simplified formula for frictional head loss of gas flowing is

$${h}_{f} = 4. f . L . \frac{{u}^{2}}{2 g} \qquad Equation 2$$

In the case of abrupt enlargements and abrupt contractions in the cross sectional area of a pipe then the ‘k’ factor is often derived from practical testing to obtain accurate values. Fluid flowing in corrugated pipe is, as a result of the additional components of head loss, always higher for a given ‘nominal bore’ than an equivalent smooth pipe.
Using an example of a 20 mm Serviflex® pipe, the corrugations therein generate head loss roughly 1.4 to 1.5× that of an equivalent smooth pipe of the same dimensions. Nevertheless the corrugations in Serviflex® pipe are relatively smooth compared to the body portion of the claimed invention.

### Example of Geometry Selection

In one example, in order to determine suitable pipe geometry to satisfy the claimed invention, the external diameter (304) of the spigot 218, 220 sections and the external diameter (302) across the peaks 204 of the corrugated body portion 202 are first selected. Preferably, the spigot has a first outside diameter and wall thickness defined so as to ensure compatibility to other standard pipeline components. These are set in some respects to minimise tooling variants and follow pipe scaling principles already in use. Table 1 depicts typical scaling required for corrugated pipes having particular external spigot diameters 218, 220 and external peak 204 diameters (302) using scaling principles known in the art. Taking the example of the first row in Table 1, according to the present invention, a flexible pipe connector having spigots with an external diameter of 20 mm, the peak external diameter must be increased, specifically, it must be 125% that of the spigots, i.e. 25 mm. Similarly, taking the example of the sixth row in Table 1, according to the present invention, a flexible pipe connector having spigots with an external diameter of 63 mm, the peak external diameter must be 119% that of the spigots, i.e. 75 mm.

The variable in the geometry selection then remains the shape of the corrugation and in particular, the diameter of the most constrictive part of the trough 206 of the corrugated body portion 202. This can be traded against pitch, given that the head loss is a function of the enlargement of flow entering the peak 204 and the contraction of flow exiting the peak, entering the trough 206 multiplied by the number of times the effect occurs. This can be predicted using mathematical methods or derived empirically.

In this example, the controlling feature enabling the limitation of maximum head loss across the length of the pipe connector is the internal diameter of the peaks 204 and troughs 206, which must be sufficiently large that the component of head loss generated by both frictional and expansion/contraction is reduced to lower levels than those which would be experienced in an equivalent smooth bored pipe experiencing only frictional head loss. This is achieved by ensuring that the minimum internal diameter (306) at any point throughout the corrugated body portion 202, defined at the troughs, is greater than the internal diameter of an equivalent smooth bored pipe. Generally, the corrugated body portion has a minimum internal diameter which is one nominal (defined by industry standards) diameter greater than the spigot (approximately 20-30%). The minimum internal diameter (306) in the corrugated body portion 202 is typically 10-15% greater than the internal diameter (304) of the smooth bored spigot to which it is attached.

The net result of the above provides that the velocity through the corrugated body portion 202 is of the order of 20% lower than through the smooth spigot sections 218, 220. This ensures that the components of head loss associated with friction, expansion and contraction over each corrugation pitch result in a head loss lower than the pure frictional losses in the integral spigots over for a desired volumetric flow rate. Consequently, the multiplier of the velocity term in equations 1 and 2 is approximately 35-36% lower in the corrugated body portion 202 than in the smooth spigots. This is then no greater than the head loss expected for an equivalent smooth bored pipe. . . .

For example, if the minimum internal diameter of the corrugated portion 202 is 12-13% greater than the internal diameter of an equivalent smooth bored pipe (say, 10-15% range and/or >10%) then the velocity of gas flowing through the corrugated body portion will be reduced by approximately 20%. As head loss is a function of velocity squared, all terms in equations 1 and 2 show a marked reduction in head loss.

TABLE 1
Examples of the increase in external diameter required
from the spigot to the corrugation peak.

| Spigot External | Corrugation Peak | % |
|---|---|---|
| Diameter | External Diameter | Increase |
| 20 | 25 | 125% |
| 25 | 32 | 128% |
| 32 | 40 | 125% |
| 40 | 50 | 125% |
| 50 | 63 | 126% |
| 63 | 75 | 119% |

Whilst the description refers throughout to the example of 25 SDR 11 polyethylene pipe forms, it will be appreciated that the underlying principles are scalable for a range of pipe dimensions and materials.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A flexible pipe connector for joining a pressurised mains pipe to a service pipe, the connector comprising:
a corrugated longitudinal body portion having a first end, a second end and an internal bore therebetween, said longitudinal body portion further comprising a plurality of corrugations spaced along the length thereof, the corrugations defining a maximum internal diameter of the bore at a peak of a corrugation and a minimum internal diameter of the bore at a trough of a corrugation;
a first spigot socket at said first end of the longitudinal body portion; and
a second spigot socket at said second end of the longitudinal body portion;
wherein, for a defined volumetric flow rate, the head loss of a fluid flowing through said body portion is no greater than if the fluid were flowing in a smooth bored pipe of the same length and having the same internal diameter as the first and second spigot sockets; and
wherein the minimum internal diameter of said corrugated internal bore is greater than the maximum internal diameter of said first and second spigots.

2. A flexible pipe connector as claimed in claim 1, wherein said first and/or second spigot sockets have dimensions determined by international, national and/or regional standards for polyethylene pressure pipe systems.

3. A flexible pipe connector as claimed in claim 1, wherein said first and/or second spigot sockets have an outside diameter of 25 mm.

4. A flexible pipe connector as claimed in claim 1, wherein said first and/or second spigot sockets have a wall thickness of 2.3 mm.

5. A flexible pipe connector as claimed in claim 1, wherein the volumetric flow rate is between 0 and 4 standard cubic metres per hour (SCMH).

6. A flexible pipe connector as claimed in claim 1, wherein said corrugations are equally spaced along the length of the corrugated body portion.

7. A flexible pipe connector as claimed in claim 1, wherein the minimum outside diameter of said corrugated body portion is 32mm.

8. A flexible pipe connector as claimed in claim 1, wherein the minimum outside diameter of said corrugated body portion is at least 19% greater than the outside diameter of said first and second spigots.

9. A flexible pipe connector as claimed in claim 8, wherein the minimum outside diameter of said corrugated body portion is between 19% and 30% greater than the outside diameter of said first and second spigots.

10. A flexible pipe connector as claimed in claim 9, wherein the minimum outside diameter of said corrugated body portion is at least 25% greater than the outside diameter of said first and second spigots.

11. A flexible pipe connector as claimed in claim 1, wherein the minimum outside diameter of said corrugated body portion is in accordance with ISO11922-1:1997.

12. (canceled)

13. (canceled)

14. A flexible pipe connector as claimed in claim 1, wherein said spigot sockets are more than twice the length required for a normal connection.

15. A flexible pipe connector as claimed in claim 1, wherein said spigot sockets are longer than a conventional pipe stub.

16. A flexible pipe connector as claimed in claim 1, wherein the corrugated body portion has a bend radius of 1 D-1.5 D.

17. A flexible pipe connector as claimed in claim 1, wherein the flexible pipe connector comprises synthetic polyolefin.

18. A flexible pipe connector as claimed in claim 1, wherein the flexible pipe connector is a unitary integrally-formed component.

19. (canceled)

20. A method for joining a pressurised mains pipe to an individual service pipe comprising the steps of:
disconnecting the pressurised mains pipe from service;
providing a flexible pipe connector as claimed in any of the preceding claims;
attaching said first spigot socket of the flexible pipe connector to the mains pipe;
bending said corrugated body portion of the flexible pipe connector such that said second spigot socket is aligned with an opening of the service pipe; and
attaching said second spigot of the flexible pipe connector to the service pipe.

21. A method as claimed in claim 20, wherein said first spigot socket is attached to the mains pipe via a tapping tee.

22. (canceled)

23. A kit for connecting a pressurised mains pipe to an individual service pipe, the kit comprising:
a flexible pipe connector comprising:
a corrugated longitudinal body portion having a first end, a second end and an internal bore therebetween, said longitudinal body portion further comprising a plurality of corrugations spaced along the length thereof, the corrugations defining a maximum internal diameter of the bore at a peak of a corrugation and a minimum internal diameter of the bore at a trough of a corrugation;
a first spigot socket at said first end of the longitudinal body portion; and
a second spigot socket at said second end of the longitudinal body portion;
wherein, for a defined volumetric flow rate, the head loss of a fluid flowing through said body portion is no greater than if the fluid were flowing in a smooth bored pipe of the same length and having the same internal diameter as the first and second spigot sockets; and
wherein the minimum internal diameter of said corrugated internal bore is greater than the maximum internal diameter of said first and second spigots,
and a tapping tee assembly.

24. A kit as claimed in claim 23 further comprising a length of plastics pipe for lining the pressurised mains pipe.

25. (canceled)

26. (canceled)

27. (canceled)
